(19) United States
(12) Patent Application Publication
(10) Pub. No.: US 2016/0267414 A1
(43) Pub. Date: Sep. 15, 2016

(54) PROJECT SUCCESS DIAGNOSIS APPARATUS

(71) Applicant: I-Think Corporation, Tokyo (JP)

(72) Inventor: Kentaro ITO, Tokyo (JP)

(21) Appl. No.: 15/065,030

(22) Filed: Mar. 9, 2016

(30) Foreign Application Priority Data
Mar. 13, 2015 (JP) 2015-051216

(51) Int. Cl. G06Q 10/06

(52) U.S. Cl. CPC G06Q 10/06313; G06Q 10/0635

(57) ABSTRACT

Disclosed is a project success diagnosis apparatus that diagnoses success or failure of a project based on performance of a plurality of stakeholders. The project success diagnosis apparatus includes: a first storage unit configured to store required performance as numeric values for a plurality of first parameters used to evaluate an ability with which one of the plurality of stakeholders fulfills an expected function; a function evaluation calculation unit configured to calculate ratios of evaluation values relating to the respective first parameters to the required performance and configured to calculate an evaluation value relating to the stakeholder; a second storage unit configured to store affecting degrees for all the stakeholders; and a success probability calculation unit configured to calculate basic values relating to the respective stakeholders and configured to add together the calculated basic values relating to the respective stakeholders to calculate a project success probability.

### BACKGROUND OF THE INVENTION

1. Field of the Invention

The present invention relates to a technology for evaluating a project success degree based on the evaluation of the abilities of stakeholders.

2. Description of the Related Art

In general, projects as business plans include multiple steps, involve multiple persons and organizations, and require a relatively long time until the projects end. The subjects of the projects hope to successfully end the projects, but the success or failure of the projects is complexly intertwined with various factors. Therefore, it is required to consider and deal with an enormous amount of elements for the success of the projects without any problem.

On the other hand, for the success of the projects without any problem, it is important to use the experiences of dealing with problems, issues, or the like in past projects and the accumulation of the experiences to foresee factors hindering the success of the projects and discuss countermeasures for them in advance.

Under such circumstances, researches and developments on project management using computer systems have been extensively made as in, for example, Patent Documents 1 to 5.

Patent Document 1: Japanese Patent Application Laid-open No. 2006-323636

Patent Document 2: Japanese Patent Application Laid-open No. 2003-345955

Patent Document 3: Japanese Patent Application Laid-open No. 2001-256421

Patent Document 4: Japanese Patent Application Laid-open No. 2001-195483

Patent Document 5: Japanese Patent Application Laid-open No. 11-066150

### SUMMARY OF THE INVENTION

In the above related arts, the success or failure of projects greatly depends on the performance of stakeholders representing individuals or organizations affected by or affecting the projects, but the casual relationship between the performance of the stakeholders and the success or failure of the projects may not be evaluated.

In view of the above problem, the present invention has an object of providing a project success diagnosis apparatus that evaluates abilities with which stakeholders representing individuals or organizations affected by or affecting a project fulfill expected functions and diagnoses the success or failure of the project based on the evaluation.

An embodiment of a disclosed project success diagnosis apparatus diagnoses success or failure of a project based on performance of a plurality of stakeholders representing individuals or organizations affected by or affecting the project. The project success diagnosis apparatus includes: a first storage unit configured to store required performance, which represents standards assumed to be required for the success of the project, as numeric values for a plurality of first parameters used to evaluate an ability with which one of the plurality of stakeholders fulfills an expected function; a function evaluation calculation unit configured to calculate ratios of evaluation values relating to the respective first parameters to the required performance stored in the first storage unit and configured to calculate an evaluation value relating to the stakeholder as an average value of the calculated ratios relating to the respective first parameters; a second storage unit configured to store affecting degrees on the success of the project for all the stakeholders, the affecting degrees being set such that a sum of all the affecting degrees becomes 1; and a success probability calculation unit configured to multiply the evaluation values, which are calculated by the function evaluation calculation unit and relate to the respective stakeholders, by the affecting degrees, which are stored in the second storage unit and relate to the respective stakeholders, to calculate basic values relating to the respective stakeholders and configured to add together the calculated basic values relating to the respective stakeholders to calculate a project success probability representing a possibility of the success of the project.

A disclosed project success diagnosis apparatus is allowed to evaluate abilities with which stakeholders representing individuals or organizations affected by or affecting a project fulfill expected functions and diagnose the success or failure of the project based on the evaluation.

Other objects, features and advantages of the present invention will become more apparent from the following detailed description when read in conjunction with the accompanying drawings.

### BRIEF DESCRIPTION OF THE DRAWINGS

FIG. 1 is a diagram showing the outline of a project success diagnosis apparatus according to an embodiment;

FIG. 2 is a function block diagram of the project success diagnosis apparatus according to the embodiment;

FIG. 3 is a diagram (1) describing information processing performed by the project success diagnosis apparatus according to the embodiment;

FIG. 4 is a diagram (2) describing information processing performed by the project success diagnosis apparatus according to the embodiment;

FIG. 5 is a diagram showing a hardware configuration example of the project success diagnosis apparatus according to the embodiment; and

FIG. 6 is a flowchart showing the flow of the information processing performed by the project success diagnosis apparatus according to the embodiment.

### DETAILED DESCRIPTION OF THE PREFERRED EMBODIMENTS

A description will be given, with reference to the drawings, of an embodiment for carrying out the present invention.

(Outline of Project Success Diagnosis Apparatus According to Embodiment)

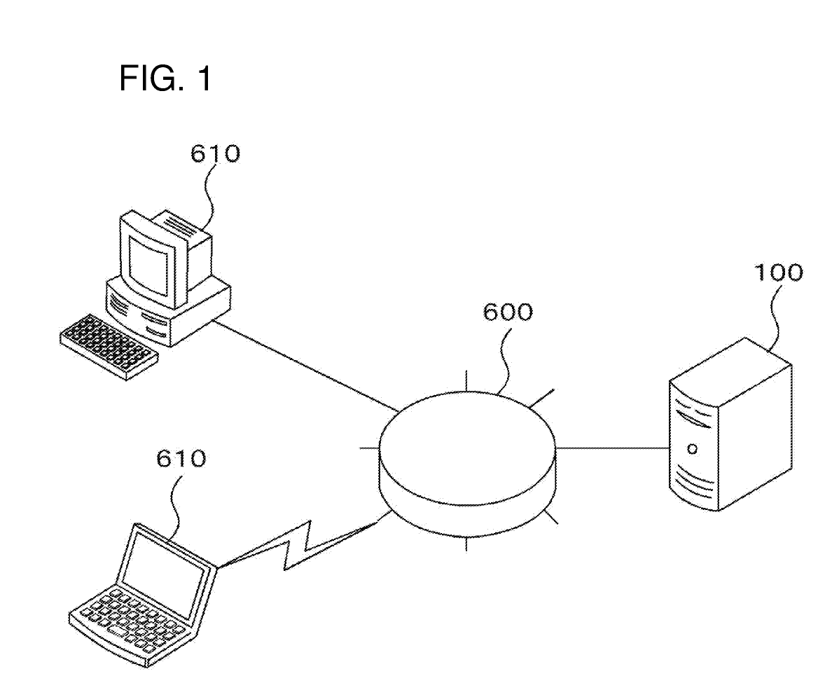

A description will be given, with reference to FIG. 1, of the outline of a project success diagnosis apparatus (hereinafter simply called a “diagnosis apparatus”) 100 according to the embodiment. FIG. 1 is a diagram describing the outline of the diagnosis apparatus 100.

As shown in FIG. 1, the diagnosis apparatus 100 is connected to a user terminal 610 via a communication network 600, and functions provided by the diagnosis apparatus 100 are used by the user terminal 610 operated by a user.

The diagnosis apparatus 100 diagnoses success or failure 220 of a project 210 according to performance 240 of stakeholders 230 defined as persons involved in the project 210, organizations or individuals affected by the project 210, and organizations or individuals affecting the project 210. Here, the performance 240 of the stakeholders 230 represents abilities (evaluation values) with which the stakeholders are allowed to fulfill expected functions.

The diagnosis apparatus 100 diagnoses the success or failure 220 of the project 210 based on the performance 240 of a plurality of stakeholders 230. Further, in view of the success or failure of the project, the diagnosis apparatus 100 calculates (diagnoses) the performance 240 of one of the stakeholders 230 based on evaluation values 280 relating to a plurality of parameters used to evaluate the performance 240. Here, the parameters used to evaluate the performance 240 of the stakeholder 230 in view of the success or failure of the project will be called factors 270.

In addition, in view of the success or failure of the project, the diagnosis apparatus 100 calculates (diagnoses) the evaluation value 280 of one of the factors 270 based on evaluation values 320 relating to a plurality of parameters used to evaluate the evaluation value 280. Here, the parameters used to evaluate the evaluation value 280 of the factor 270 in view of the success or failure of the project will be called items 310.

As described above, the diagnosis apparatus 100 diagnoses the success or failure 220 of the project 210 with the three-stage bottom-up structure of the stakeholders 230, the factors 270, and the items 310. Note that the diagnosis apparatus 100 may omit the evaluation process of the factors 270 based on the items 310 and diagnose the success or failure 220 of the project 210 with the two-stage bottom-up structure of the stakeholders 230 and the factors 270.

The diagnosis apparatus 100 provides not only the possibility of the success of the project 210 under a current environment and but also information as to how the possibility of the success of the project 210 may be changed with changes in the evaluations (contents serving as the evaluation bases) of the respective parameters of the stakeholders 230, the factors 270, and the items 310.

On the other hand, the diagnosis apparatus 100 stores events 360 defined as problems, issues, or the like occurring in past projects 210 and the factors 270 causing the occurrence of the events 360. For the project 210 to be diagnosed, the diagnosis apparatus 100 diagnoses the probability of the occurrence of the events 360 based on the evaluation values 280 of the respective factors 270. Under a current project environment, the diagnosis apparatus 100 provides an opportunity to discuss in advance countermeasures for the events 360 that may occur in the future.

(Operation Principle of Project Success Diagnosis Apparatus According to Embodiment)

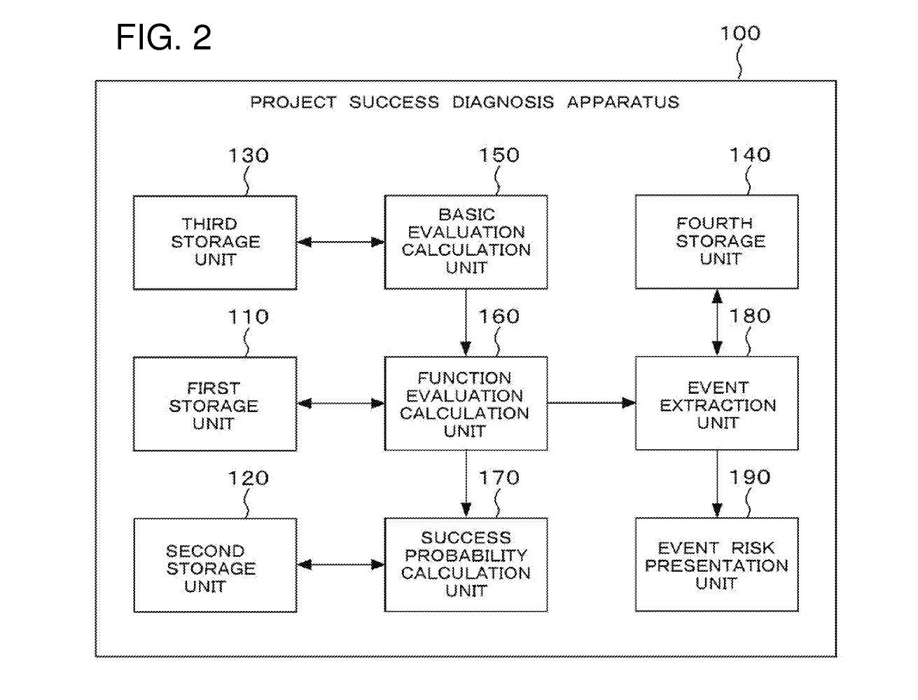

A description will be given, with reference to FIGS. 2 to 4, of the operation principle of the diagnosis apparatus 100 according to the embodiment. FIG. 2 is a function block diagram of the diagnosis apparatus 100. As shown in FIG. 2, the diagnosis apparatus 100 has a first storage unit 110, a second storage unit 120, a third storage unit 130, a fourth storage unit 140, a basic evaluation calculation unit 150, a function evaluation calculation unit 160, a success probability calculation unit 170, an event extraction unit 180, and an event risk presentation unit 190.

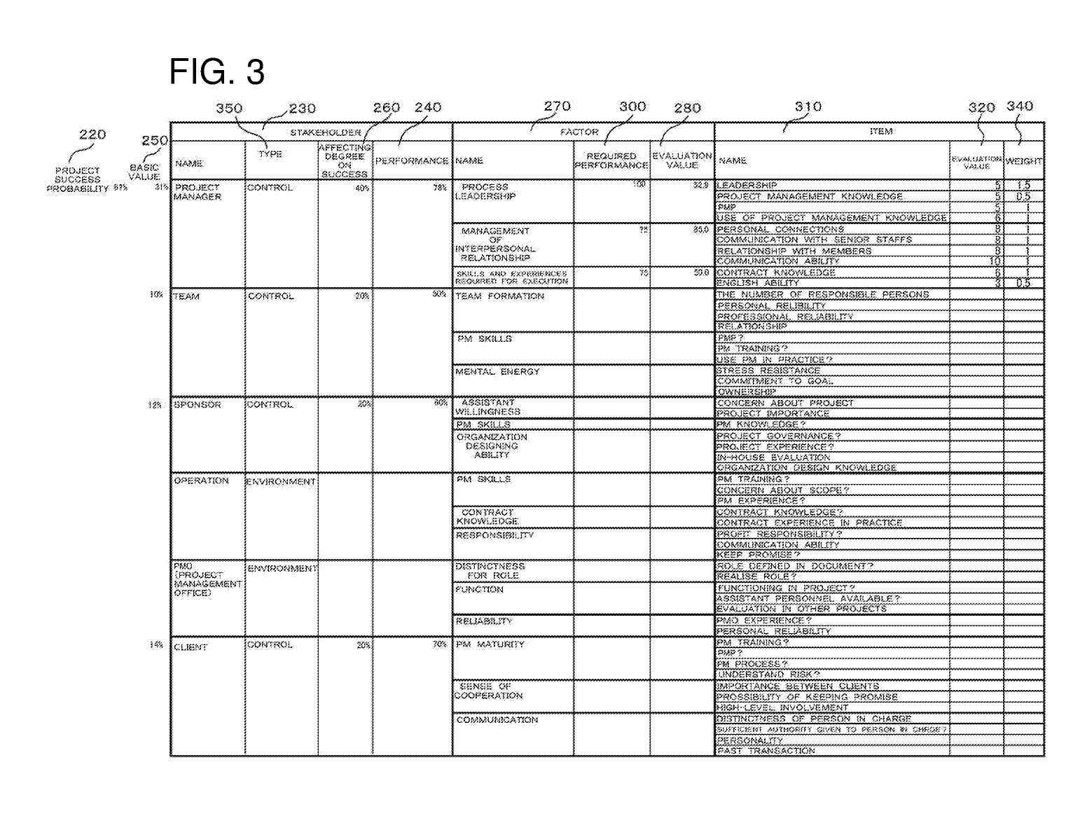

FIG. 3 is a diagram describing information processing in which the diagnosis apparatus 100 diagnoses the success or failure 220 of the project 210 with the three-stage bottom-up structure of the stakeholders 230, the factors 270, and the items 310.

For the respective parameters of the factors 270, the first storage unit 110 stores, as numeric values, required performance (required evaluation values) 300 representing standards assumed to be required for the success of the project 210. For example, as shown in FIG. 3, the first storage unit 110 stores “100” as the required evaluation value 300 for “process leadership” representing the parameter of one of the factors 270, and stores “75” as the required evaluation value 300 for “management of inter-personal relationship” representing the parameter of one of the factors 270. Note that many blank columns of the factors 270 in FIG. 3 are only for the sake of convenience and respective numeric values are originally set and calculated for all the columns.

For the respective parameters of the stakeholders 230, the second storage unit 120 stores affecting degrees 260 on the success of the project 210. Note that the affecting degrees 260 stored in the second storage unit 120 are set such that the sum of all the degrees becomes “1.” For example, as shown in FIG. 3, the second storage unit 120 stores “40%” as the affecting degree 260 for “project manager” representing the parameter of one of the stakeholders 230, and stores “20%” as the affecting degree 260 for “team” representing the parameter of one of the stakeholders 230.

In addition, for the respective parameters of the stakeholders 230, the second storage unit 120 stores attribute information 350 as to whether a content is controllable by the operation subject of the project 210. For example, as shown in FIG. 3, the second storage unit 120 stores “control” as the attribute information 350 for “project manager” representing the parameter of one of the stakeholders 230, and stores “environment” as the attribute information 350 for “operation” representing the parameter of one of the stakeholders 230. Here, “control” as the attribute information 350 represents that a content is controllable by the operation subject of the project 210, whereas “environment” as the attribute information 350 represents that a content is not controllable by the operation subject of the project 210.

For the respective parameters of the items 310, the third storage unit 130 stores the relative inclusion degrees (weights) of the evaluation values 320 of the respective parameters of the items 310 to calculate the evaluation values 280 of the associated (corresponding) factors 270. For example, as shown in FIG. 3, the third storage unit 130 stores “1.5” as the weight 340 for “leadership” representing the parameter of one of the items 310, and stores “0.5” as the weight 340 for “project management knowledge” representing the parameter of one of the items 310. Note that many blank columns of the items 310 in FIG. 3 are only for the sake of convenience and respective numeric values are originally set for all the columns.

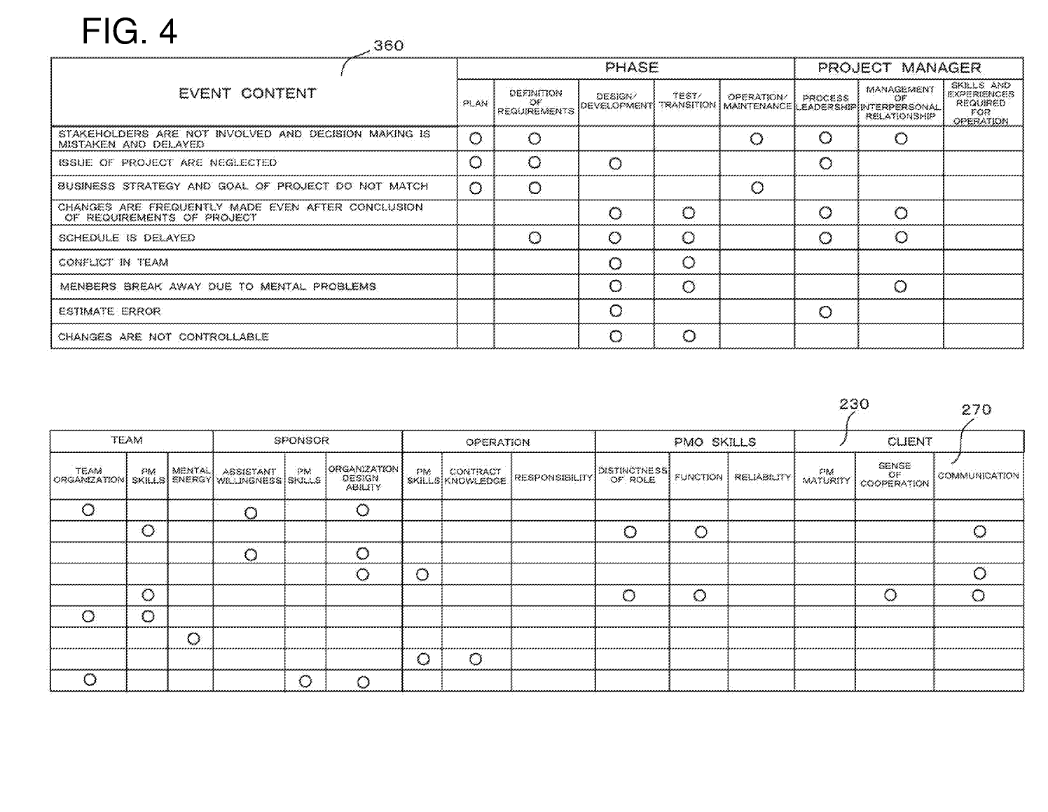

The fourth storage unit 140 stores the events 360 defined as problems, issues, or the like occurring in past projects 210 and the parameters of the factors 270 causing the occurrence of the respective events 360 so as to be associated with each other. For example, as shown in FIG. 4, the fourth storage unit 140 stores the event 360, i.e., “key stakeholders are not involved and decision making is mistaken and delayed” so as to be associated with the factors, i.e., “process leadership of project manager,” “management of inter-personal relationship of project manager,” “team organization of team,” “assist willingness of sponsor,” and “organization designing ability of sponsor,” each causing the occurrence of the event.

Note that information stored in the first storage unit 110, the second storage unit 120, the third storage unit 130, and the fourth storage unit 140 may be appropriately corrected.

The basic evaluation calculation unit 150 calculates the evaluation values 280 of the corresponding respective factors 270 based on the evaluation values 320 relating to the respective parameters of the received items 310 and the weights 340 stored in the third storage unit 130 so as to be associated with the respective parameters.

For example, in FIG. 3, for “leadership” representing the parameter of one of the items 310, the basic evaluation calculation unit 150 calculates the calculation result of 5×1.5/(1.5+0.5+1.0+1.0)×100” where the evaluation value 320 is “5,” i.e., “(about) 21.4,” as the evaluation value 330 of the item 310 after considering the weight 340.

Similarly, in FIG. 3, for “project management knowledge” representing the parameter of one of the items 310, the basic evaluation calculation unit 150 calculates the calculation result of 5×0.5/(1.5+0.5+1.0+1.0)×100 where the evaluation value 320 is “5,” i.e., “(about) 7.1,” as the evaluation value 330 after considering the weight 340.

For “PMP” and “use of project management knowledge” each representing the parameter of one of the items 310, the basic evaluation calculation unit 150 also performs the calculation in the same way to calculate “(about) 7.1” and “(about) 17.1,” respectively, as the evaluation values 330 after considering the weights 340.

Then, the basic evaluation calculation unit 150 adds together the evaluation values 330, i.e., “(about) 21.4,” “(about) 7.1,” “(about) 7.1,” and “(about) 17.1,” after considering the weights 340 relating to “leadership,” “project management knowledge,” “PMP,” and “use of project management knowledge” each representing the parameter of one of the items 310 to calculate “(about) 52.9” as the evaluation value 280 relating to “process leadership” representing the parameter of one of the factors 270. For the parameters of all the other factors 270, the basic evaluation calculation unit 150 also performs the calculation of the respective parameters of the corresponding items 310 in the same way to calculate the evaluation values 280 relating to the respective parameters.

The function evaluation calculation unit 160 calculates the ratios 290 of the evaluation values 280 relating to the respective parameters of the factors 270 to the required evaluation values 300 stored in the first storage unit 110. The ratios 290 may be regarded as the sufficiency degrees of the evaluation values 280 relative to the required evaluation values 300. Then, the function evaluation calculation unit 160 calculates the evaluation values 240 of the corresponding respective stakeholders 230 based on the calculated ratios 290 relating to the respective parameters of the factors 270. Note that only parameters corresponding to the stakeholders 230 defined in the second storage unit 120 as contents controllable by the operation subject of the project 210 may be processed by the function evaluation calculation unit 160.

For example, as shown in FIG. 3, for “process leadership” representing the parameter of one of the factors 270, the function evaluation calculation unit 160 divides the evaluation value 280, i.e., “(about) 52.9” by the required evaluation value 300, i.e., “100” to calculate “(about) 0.529” as the ratio 290. Similarly, for “management of inter-personal relationship” representing the parameter of one of the factors 270, the function evaluation calculation unit 160 divides the evaluation value 280, i.e., “85.0” by the required evaluation value 300, i.e., “75” to calculate “(about) 1.133” as the ratio 290.

Next, as the evaluation value 240 relating to “project manager” representing the parameter of one of the stakeholders 230, the function evaluation calculation unit 160 calculates the average value of the ratios 290 of the respective parameters of the corresponding factors 270, i.e., “(about) 78%.”

The success probability calculation unit 170 multiplies the affecting degrees 260 stored in the second storage unit 120 by the evaluation values 240 relating to the respective parameters of the stakeholders 230 to calculate basic values 250 used to calculate the project success probability 220. The basic values 250 may be regarded as evaluation values after considering the affecting degrees 260 on the success of the project 210.

Then, the success probability calculation unit 170 adds together the calculated basic values 250 relating to the respective stakeholders 230 to calculate the project success probability 220 representing the possibility of the success of the project 210. Note that only parameters corresponding to the stakeholders 230 defined in the second storage unit 120 as contents controllable by the operation subject of the project 210 may be processed by the success probability calculation unit 170.

For example, as shown in FIG. 3, for “project manager” representing the parameter of one of the stakeholders 230, the success probability calculation unit 170 multiplies the affecting degree 260, i.e., “40%” by the evaluation value 240, i.e., “(about) 78%” to calculate “(about) 31%” as the basic value 250. Similarly, for “team” representing the parameter of one of the stakeholders 230, the success probability calculation unit 170 multiplies the affecting degree 260, i.e., “20%” by the evaluation value 240 “(about) 50%” to calculate “(about) 10%” as the basic value 250. For the parameters of the other stakeholders 230, the success probability calculation unit 170 performs the calculation in the same way to calculate the basic values 250 relating to the respective parameters.

Next, the success probability calculation unit 170 adds together the basic values 250 relating to “project manager,” “team,” “sponsor,” and “client” each representing the parameter of one of the stakeholders 230 to calculate “about 67%” as the project success probability 220.

The event extraction unit 180 specifies parameters relating to the factors 270 each having “1” or less as the ratio 290 calculated by the function evaluation calculation unit 160, i.e., the parameters relating to the factors 270 stored in the fourth storage unit 140. Then, the event extraction unit 180 extracts the events 360 stored in the fourth storage unit 140 so as to be associated with the specified parameters relating to the factors 270.

For example, as shown in FIGS. 3 and 4, the event extraction unit 180 specifies, as parameters each having “1” or less as the ratio 290, stored in the fourth storage unit 140, and relating to the factor 270, “process leadership” having the ratio 290 “(the required evaluation value 300, i.e., “100”>(about) 52.9)” and “skills and experiences required for execution” having the ratio 290 “(the required evaluation value 300, i.e., “75”>(about) 50.0).”

Then, as shown in FIG. 4, the event extraction unit 180 extracts the events 360 stored in the fourth storage unit 140 so as to be associated with one of “process leadership” and “skills and experiences required for execution” representing parameters relating to the factors 270, i.e., “key stakeholders are not involved and decision making is mistaken and delayed,” “issues of project are neglected,” or the like. Note that the event extraction unit 180 may inform the user terminal 610 of information on the extracted events 360, i.e., “key stakeholders are not involved and decision making is mistaken and delayed,” “issues of project are neglected,” or the like.

The event risk presentation unit 190 specifies parameters relating to the factors 270 stored in the fourth storage unit 140 so as to be associated with the events extracted by the event extraction unit 180, and extracts a minimum one of the ratios 290 relating to the specified parameters. Then, the event risk presentation unit 190 presents, together with the contents of the events 360 extracted by the event extraction unit 180, the extracted ratio 290 as an index representing the probability of the occurrence of the events 360 to the user terminal 610.

(Hardware Configuration of Project Success Diagnosis Apparatus According to Embodiment)

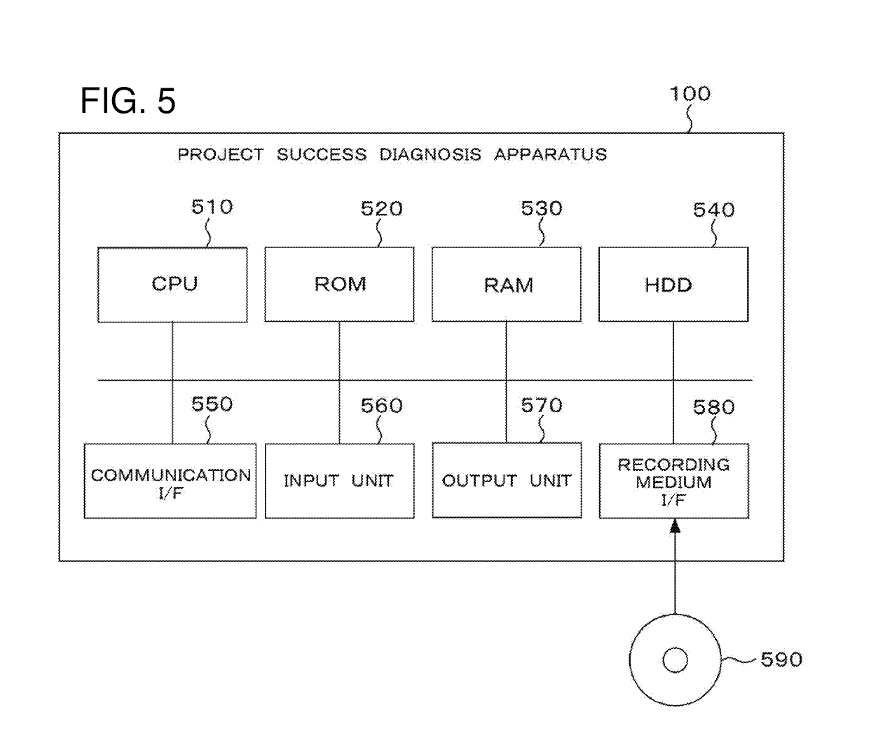

A description will be given, with reference to FIG. 5, of a hardware configuration example of the diagnosis apparatus 100 according to the embodiment. FIG. 5 is a diagram showing a hardware configuration example of the diagnosis apparatus 100. As shown in FIG. 5, the diagnosis apparatus 100 has a CPU (Central Processing Unit) 510, a ROM (Read-Only Memory) 520, a RAM (Random Access Memory) 530, a sub-storage unit 540, a communication I/F 550, an input unit 560, a display unit 570, and a recording medium I/F 580.

The CPU 510 is a unit that runs a program stored in the ROM 520, performs the calculation processing of data developed (loaded) into the RAM 530 according to a program instruction, and controls the whole diagnosis apparatus 100. The ROM 520 stores the program and the data run by the CPU 510. The RAM 530 has the program and the data developed (loaded) when the CPU 510 runs the program stored in the ROM 520, and temporarily holds calculation data during calculation.

The sub-storage unit 540 is a unit that stores an OS (Operating System) representing basic software, an application program according to the embodiment, or the like together with associated data. The sub-storage unit 540 includes the first storage unit 110, the second storage unit 120, the third storage unit 130, and the fourth storage unit 140, and serves as, for example, a HDD (Hard Disc Drive), a flash memory, or the like.

The communication I/F 550 is an interface that is connected to a communication network such as a wired/wireless LAN (Local Area Network) and the Internet and used to exchange data with other apparatuses having a communication function.

The input unit 560 is a unit such as a keyboard used to input data to the diagnosis apparatus 100. The display unit (output unit) 570 is a unit that is constituted by a LCD (Liquid Crystal Display) or the like and serves as a user interface used when a user uses or variously sets up the functions of the diagnosis apparatus 100. The recording medium I/F 580 is an interface used to send/receive data to/from the recording medium 590 such as a CD-ROM, a DVD-ROM, and a USB memory.

The respective units of the diagnosis apparatus 100 may be realized when the CPU 510 runs a program corresponding to the respective units stored in the ROM 520 or the sub-storage unit 540. In addition, for the respective units of the diagnosis apparatus 100, processing relating to the respective unit may be realized as hardware. Moreover, a program according to the embodiment of the present invention may be read from an external server via the communication I/F 550 or may be read from the recording medium 590 via the recording medium I/F 580 to be run by the diagnosis apparatus 100.

(Processing Example by Project Success Diagnosis Apparatus According to Embodiment)

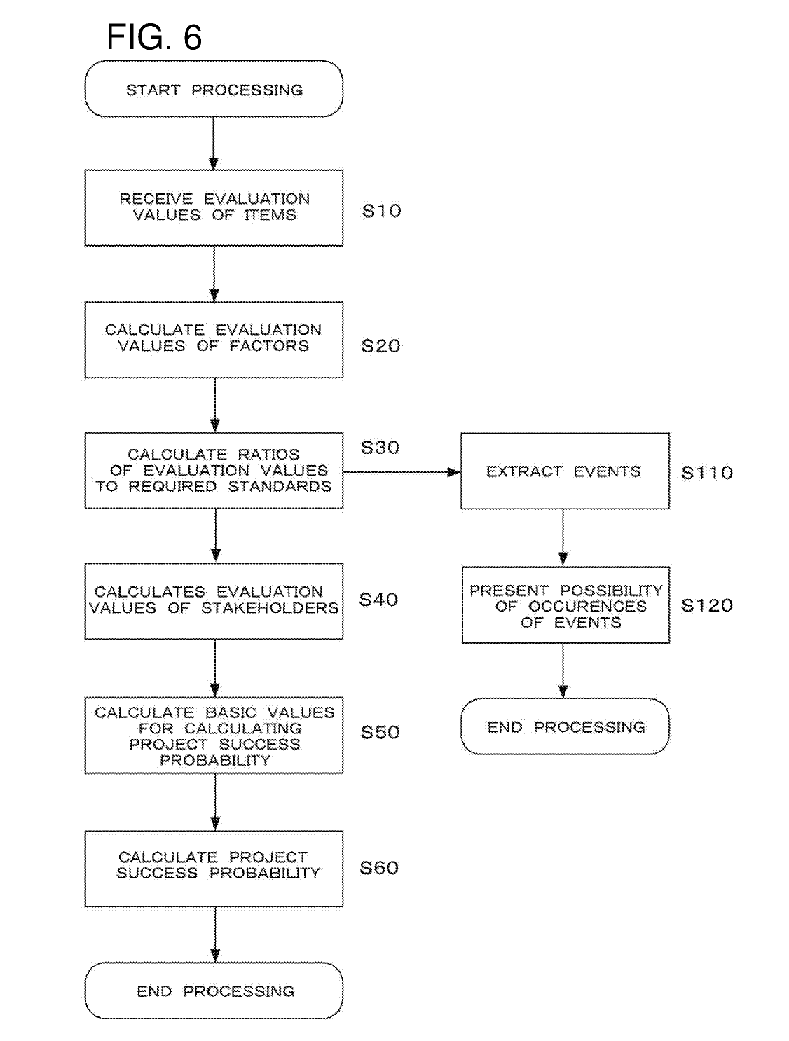

A description will be given, with reference to FIG. 6, of the flow of information processing by the diagnosis apparatus 100 according to the embodiment. FIG. 6 is a flowchart showing the flow of a processing example by the diagnosis apparatus 100.

(1) Calculation Processing of the Project Success Probability 220 by the Diagnosis Apparatus 100

In S10, the basic evaluation calculation unit 150 receives the evaluation values 320 relating to the respective parameters of the items 310 from the user terminal 610. As shown in FIG. 3, the basic evaluation calculation unit 150 receives the evaluation values 320 of the parameters of the items 310.

In S20, the basic evaluation calculation unit 150 calculates the evaluation values 280 of the corresponding respective factors 270 based on the evaluation values 320 relating to the respective parameters of the items 310 received in S10 and the weights 340 stored in the third storage unit 130 so as to be associated with the respective parameters.

As shown in FIG. 3, for “leadership” representing the parameter of one of the items 310, the basic evaluation calculation unit 150 calculates the calculation result of 5×1.5/(1.5+0.5+1.0+1.0)×100 where the evaluation value 320 is “5,” i.e., “(about) 21.4,” as the evaluation value 330 of the item 310 after considering the weight 340.

Similarly, for “project management knowledge” representing the parameter of one of the items 310, the basic evaluation calculation unit 150 calculates the calculation result of 5×0.5/(1.5+0.5+1.0+1.0)×100 where the evaluation value 320 is “5,” i.e., “(about) 7.1,” as the evaluation value 330 after considering the weight 340.

For “PMP” and “use of project management knowledge” each representing the parameter of one of the items 310, the basic evaluation calculation unit 150 also performs the calculation in the same way to calculate “(about) 7.1” and “(about) 17.1,” respectively, as the evaluation values 330 after considering the weights 340.

Then, the basic evaluation calculation unit 150 adds together the evaluation values 330 after considering the weights 340 relating to “leadership,” “project management knowledge,” “PMP,” and “use of project management knowledge” each representing the parameter of one of the items 310, i.e., “(about) 21.4,” “(about) 7.1,” “(about) 7.1,” and “(about) 17.1” to calculate “(about) 52.9” as the evaluation value 280 relating to “process leadership” representing the parameter of one of the factors 270. For the parameters of all the other factors 270, the basic evaluation calculation unit 150 also performs the calculation of the respective parameters of the corresponding items 310 in the same way to calculate the evaluation values 280 relating to the respective parameters.

In S30, the function evaluation calculation unit 160 calculates the ratios 290 of the evaluation values 280 relating to the respective parameters of the factors 270 to the required evaluation values 300 stored in the first storage unit 110. The ratios 290 may be regarded as the sufficiency degrees of the evaluation values 280 relative to the required evaluation values 300.

As shown in FIG. 3, for “process leadership” representing the parameter of one of the factors 270, the function evaluation calculation unit 160 divides the evaluation value 280, i.e., “(about) 52.9” by the required evaluation value 300, i.e., “100” to calculate “(about) 0.529” as the ratio 290. Similarly, for “management of inter-personal relationship” representing the parameter of one of the factors 270, the function evaluation calculation unit 160 divides the evaluation value 280, i.e., “85.0” by the required evaluation value 300, i.e., “75” to calculate “(about) 1.133” as the ratio 290.

In S40, the function evaluation calculation unit 160 calculates the evaluation values 240 of the corresponding respective stakeholders 230 based on the ratios 290 relating to the respective parameters of the factors 270 calculated in S30.

As shown in FIG. 3, the function evaluation calculation unit 160 calculates the average value of the ratios 290 of the respective parameters of the corresponding factors 270, i.e., “(about) 78%” as the evaluation value 240 relating to “project manager” representing the parameter of one of the stakeholders 230.

In S50, the success probability calculation unit 170 multiplies the affecting degrees 260 stored in the second storage unit 120 by the evaluation values 240 relating to the respective parameters of the stakeholders 230 to calculate the basic values 250 used to calculate the project success probability 220. The basic values 250 may be regarded as evaluation values after considering the affecting degrees 260 on the success of the project 210.

As shown in FIG. 3, for “project manager” representing the parameter of one of the stakeholders 230, the success probability calculation unit 170 multiplies the affecting degree 260, i.e., “40%” by the evaluation value 240, i.e., “(about) 78%” to calculate “(about) 31%” as the basic value 250.

Similarly, for “team” representing the parameter of one of the stakeholders 230, the success probability calculation unit 170 multiplies the affecting degree 260, i.e., “20%” by the evaluation value 240, i.e., “(about) 50%” to calculate “(about) 10%” as the basic value 250. For the parameters of the other stakeholders 230, the success probability calculation unit 170 also performs the calculation in the same way to calculate the basic values 250 relating to the respective parameters.

In S60, the success probability calculation unit 170 adds together the basic values 250 relating to the respective stakeholders 230 calculated in S50 to calculate the project success probability 220 representing the possibility of the success of the project 210. Note that only parameters corresponding to the stakeholders 230 defined in the second storage unit 120 as contents controllable by the operation subject of the project 210 are processed by the success probability calculation unit 170.

As shown in FIG. 3, the success probability calculation unit 170 adds together the basic values 250 relating to “project manager,” “team,” “sponsor,” and “client” each representing the parameter of one of the stakeholders 230 to calculate “about 67%” as the project success probability 220.

Based on the above processing, the diagnosis apparatus 100 is allowed to evaluate abilities with which the stakeholders 230, i.e., individuals or organizations affected by or affecting the project 210 fulfill expected functions, and diagnose the success or failure 220 of the project 210 based on the evaluations.

The diagnosis apparatus 100 also provides information as to how the possibility of the success of the project 210 may be changed with changes in the evaluations (contents serving as the evaluation bases) of the respective parameters of the stakeholders 230, the factors 270, and the items 310. That is, the diagnosis apparatus 100 is allowed to give information as to how the success or failure of the project 210 is affected by various changes in resource allocation such as personnel shifts, organization shifts, and evaluation-axis shifts, and users are allowed to appropriately design resource allocation in the project 210.

(2) Processing for Specifying Risk of Occurrence of Events 360 by Diagnosis Apparatus 100

The description of information processing in S10 to S30 will be omitted since it is the same as the above calculation processing (1) of the project success probability 220 by the diagnosis 100. After the information processing in S30, the information processing by the diagnosis apparatus 100 transits to processing in S110.

In S110, the event extraction unit 180 specifies parameters relating to the factors 270 each having “1” or less as the ratio 290 calculated in S30, i.e., the parameters relating to the factors 270 stored in the fourth storage unit 140.

Then, in S110, the event extraction unit 180 extracts the events 360 stored in the fourth storage unit 140 so as to be associated with the specified parameters relating to the factors 270.

As shown in FIGS. 3 and 4, the event extraction unit 180 specifies, as parameters each having “1” or less as the ratio 290, stored in the fourth storage unit 140, and relating to the factor 270, “process leadership” having the ratio 290 “(the required evaluation value 300, i.e., “100”>52.9)” and “skills and experiences required for execution” having the ratio 290 “(the required evaluation value 300, i.e., “75”>50.0).”

Then, as shown in FIG. 4, the event extraction unit 180 extracts the events 360 stored in the fourth storage unit 140 so as to be associated with one of “process leadership” and “skills and experiences required for execution” representing the parameters relating to the factors 270, i.e., “key stakeholders are not involved and decision making is mistaken and delayed,” “issues of project are neglected,” or the like.

Note that the event extraction unit 180 may inform the user terminal 610 of information on the events 360 extracted in S110, i.e., “key stakeholders are not involved and decision making is mistaken and delayed,” “issues of project are neglected,” or the like.

In S120, the event risk presentation unit 190 specifies parameters relating to the factors 270 stored in the fourth storage unit 140 so as to be associated with the events 360 extracted in S110, and extracts a minimum one of the ratios 290 relating to the specified parameters.

Then, in S120, the event risk presentation unit 190 presents, together with the contents of the events 360 extracted in S110, the extracted ratio 290 as an index representing the probability of the occurrence of the events 360 to the user terminal 610.

Based on the above processing, the diagnosis apparatus 100 is allowed to provide an opportunity to discuss in advance countermeasures for the events 360 that may occur in the future under a current environment.

The present invention is not limited to the specifically disclosed embodiment, but variations and modifications may be made without departing from the scope of the present invention.

The present application is based on Japanese Priority Application No. 2015-051216 filed on Mar. 13, 2015, the entire contents of which are hereby incorporated herein by reference.

What is claimed is:

1. A project success diagnosis apparatus that diagnoses success or failure of a project based on performance of a plurality of stakeholders representing individuals or organizations affected by or affecting the project, the project success diagnosis apparatus comprising:
a first storage unit configured to store required performance, which represents standards assumed to be required for the success of the project, as numeric values for a plurality of first parameters used to evaluate an ability with which one of the plurality of stakeholders fulfills an expected function;
a function evaluation calculation unit configured to calculate ratios of evaluation values relating to the respective first parameters to the required performance stored in the first storage unit and configured to calculate an evaluation value relating to the stakeholder as an average value of the calculated ratios relating to the respective first parameters;
a second storage unit configured to store affecting degrees on the success of the project for all the stakeholders, the affecting degrees being set such that a sum of all the affecting degrees becomes 1; and
a success probability calculation unit configured to multiply the evaluation values, which are calculated by the function evaluation calculation unit and relate to the respective stakeholders, by the affecting degrees, which are stored in the second storage unit and relate to the respective stakeholders, to calculate basic values relating to the respective stakeholders and configured to add together the calculated basic values relating to the respective stakeholders to calculate a project success probability representing a possibility of the success of the project.

2. The project success diagnosis apparatus according to claim 1, further comprising:
a third storage unit configured to store, for a plurality of second parameters used to evaluate the respective first parameters used to evaluate the ability with which the stakeholder fulfills the expected function, relative consideration degrees of the respective second parameters to perform the evaluation; and
a basic evaluation calculation unit configured to calculate the evaluation values relating to the respective first parameters used to evaluate the ability with which the stakeholder fulfills the expected function, based on evaluation values for the respective second parameters used to evaluate the respective first parameters used to evaluate the ability with which the stakeholder fulfills the expected function and the consideration degrees stored in the third storage unit.

3. The project success diagnosis apparatus according to claim 1, wherein
attribute information as to whether a content is controllable by an operation subject for the success of the project is defined for each of the stakeholders, and
the success probability calculation unit processes only information relating to the stakeholders each having the attribute information representing that the content is controllable by the operation subject for the success of the project.

4. The project success diagnosis apparatus according to claim 1, further comprising:
a fourth storage unit configured to store events and the first parameters so as to be associated with each other, the events representing problems or issues occurring in a past project, the first parameters causing the occurrence of the events and being used to evaluate the ability with which the stakeholder fulfills the expected function; and
an event extraction unit configured to extract the events from the fourth storage unit, the events being associated with the first parameters each having 1 or less as the ratio calculated by the function evaluation calculation unit and used to evaluate the ability with which the stakeholder fulfills the expected function.

5. The project success diagnosis apparatus according to claim 4, further comprising:
an event risk presentation unit configured to present a minimum one of the ratios to a user as an occurrence probability of the events, the ratios relating to the first parameters stored in the fourth storage unit so as to be associated with the events extracted by the event extraction unit and used to evaluate the ability with which the stakeholder fulfills the expected function.

6. A project success diagnosis method performed by an apparatus that diagnoses success or failure of a project based on performance of a plurality of stakeholders representing individuals or organizations affected by or affecting the project, the project success diagnosis method comprising:
calculating ratios of evaluation values relating to respective first parameters to required performance stored in a first storage unit and calculating an evaluation value relating to a stakeholder as an average value of the calculated ratios relating to the respective first parameters, the first storage unit storing the required performance, which represents standards assumed to be required for the success of the project, as numeric values for the plurality of first parameters used to evaluate an ability with which the one of the plurality of stakeholders fulfills an expected function; and
multiplying the calculated evaluation values relating to the respective stakeholders by affecting degrees, which are stored in a second storage unit and relate to the respective stakeholders, to calculate basic values relating to the respective stakeholders and adding together the calculated basic values relating to the respective stakeholders to calculate a project success probability representing a possibility of the success of the project, the second storage unit storing the affecting degrees on the success of the project for all the stakeholders such that a sum of all the affecting degrees becomes 1.

7. The project success diagnosis method according to claim 6, further comprising:
calculating the evaluation values relating to the respective first parameters used to evaluate the ability with which the stakeholder fulfills the expected function, based on evaluation values for respective second parameters used to evaluate the respective first parameters used to evaluate the ability with which the stakeholder fulfills the expected function and consideration degrees stored in a third storage unit, the third storage unit storing, for the plurality of second parameters used to evaluate the respective first parameters used to evaluate the ability with which the stakeholder fulfills the expected function, the relative consideration degrees of the respective second parameters to perform the evaluation.

8. The project success diagnosis method according to claim 6, wherein
attribute information as to whether a content is controllable by an operation subject for the success of the project is defined for each of the stakeholders, and
only information relating to the stakeholders each having the attribute information representing that the content is controllable by the operation subject for the success of the project is processed.

9. The project success diagnosis method according to claim 6, further comprising:
extracting events, which are associated with the first parameters each having 1 or less as the calculated ratio and used to evaluate the ability with which the stakeholder fulfills the expected function, from a fourth storage unit, the fourth storage unit storing the events and the first parameters so as to be associated with each other, the events representing problems or issues occurring in a past project, the first parameters causing the occurrence of the events and used to evaluate the ability with which the stakeholder fulfills the expected function.

10. The project success diagnosis method according to claim 9, further comprising:
presenting a minimum one of the ratios to a user as an occurrence probability of the events, the ratios relating to the first parameters stored in the fourth storage unit so as to be associated with the extracted events and used to evaluate the ability with which the stakeholder fulfills the expected function.

11. A non-transitory computer readable recording medium having recorded thereon a project success diagnosis program for causing a computer to perform the project success diagnosis method according to claim 6.
